(19) United States
(12) Patent Application Publication
(10) Pub. No.: US 2004/0220863 A1
(43) Pub. Date: Nov. 4, 2004

(54) Saved subset of configurable offering as a basis for future orders

(75) Inventors: Howard Keith Porter, Durham, NC (US); Charlie Bernard Isler, Durham, NC (US); Scott Warren Jensen, Charlotte, NC (US); David Grining, Graham, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/426,178

(22) Filed: Apr. 29, 2003

(51) Int. Cl. G06F 17/60

(52) U.S. Cl. 705/27

(57) ABSTRACT

In a rules based management system for deriving multiple catalogs from one or more ancestor catalogs, a method for allowing a customer to dynamically set up and save a configurable subset of the customer's catalog. The method does not require intervention by administrators of the one or more ancestor catalogs, saving the customer time and effort. The subset is identified as an offering released by the customer, and can be saved as an item in the customer's catalog, or saved as a sub-catalog. Products available in the customer's catalog and the subset include goods, services and capabilities. Products sold from the subset are accounted for in the same manner as products sold from the customer's regular catalog. The subset of the customer's catalog is set up and saved in real-time or near real-time, making the subset immediately available for access and ordering.

### BACKGROUND OF THE INVENTION

The present invention relates generally to the field of management of electronic catalogs and more specifically to a method for allowing a customer to set up and save a subset of the customer's catalog.

Electronic catalogs are similar to traditional paper catalogs in that they can be used to display the products, services and capabilities of a company. Electronic catalogs, however, are much more flexible than paper catalogs in that they can be quickly updated and can also be used in a manner similar to databases. Electronic catalogs can store legal and technical information, which an authorized customer can access and use to produce contracts and proposals. Electronic catalogs may also offer multiple capabilities to customers, for instance, a catalog can offer different types of reporting formats, invoicing procedures and distribution methods.

In a rules based management system for electronic catalogs, a set of rules are defined for a particular customer and the rules are applied to a data set to create the customer's catalog. When one of the rules is changed, the contents or capabilities of the catalog are changed. Sub-catalogs can easily be derived from a parent catalog by copying the rules of the parent catalog, adding one or more rules specific to the sub-catalog, and applying the rules against the data set associated with the sub-catalog to create the sub-catalog. The rules act as filters for the data and each time a different set of rules are applied to the same data set a different catalog is created. Capabilities available within a specific catalog, the types of displays presented, and other customer “entitlements” are all defined by the rules that are used to create the catalog. Subsequent descendant catalogs can also be derived from a sub-catalog. Thus, many sub-catalogs, that ultimately derive from the same base catalog, can be created and managed by a single entity through the use of a rules based management system. This system streamlines management of the catalogs and allows the entity to maintain administrative control over a wide variety of electronic catalogs.

In a rules based management system, customers gains access to their catalogs through a log-in process wherein customer provided information is used to verify the authenticity of the customer. The customer is identified during this log-in process and the rules associated with the customer are retrieved and applied to the data set to dynamically create the customer's catalog. As used herein “customer” is given a very broad definition and, besides its traditional meaning, “customer” is meant to include retailers, wholesalers, marketers, developers, manufactures and distributors. Thus a seller of computers can be a “customer” when using an electronic catalog. For example, a customer (retailer or distributor) that deals in desktop computers may have his catalog limited to products and services related to desktop computers. A problem with traditional catalog systems however, is that customers cannot create a subset of their catalog without help from the authors of the catalog or administrators of higher level catalogs. Traditionally, catalog administrators from higher levels were required to assure that items in the subset were a valid configurable subset of the original configurable offering and that they could be accounted for when ordered. This involved a long drawn out process of gathering requirements and obtaining approvals. The present invention solves this problem.

Rules and data associated with electronic catalogs are typically stored on special computers known as servers and accessed via a network. Small networks called local area networks, or LAN's, and are traditionally used to connect computers within a single building or complex. Metropolitan area networks, or MAN's, refer to networks that connect computers throughout a city. Wide area networks, or WAN's, connect geographical areas larger than a city. The Internet, which is a worldwide network, can be considered the ultimate WAN. The hardware and software used to set up and run a network is referred to as the network's infrastructure. The Internet is an association of computer networks with common standards, which enable information to be sent from any host on one network to any host on another network. Originally developed in the 1970's to support military research, the Internet has since grown and expanded to support commercial, educational, and other users. The World Wide Web is an Internet facility designed for multimedia use, in which individuals or organizations make available ‘pages’ of information to other users anywhere in the world. Access to these pages can be at no cost or, in the case of certain commercial operations, a fee can be required before access is granted. The Internet uses a client-server architecture to control the sending and receiving of information. In a client-server architecture, one computer (the server) has a supply of information and another computer (the client) requests some of the information. The request is forwarded form network to network until it reaches the network on which the server resides. The server then processes the request and responds by sending the requested information back to the client. During their travels across the Internet, requests and responses will likely encounter one or more gateways and routers. Gateways are located between computer networks and enable a network operating according to one protocol to pass messages to a second network working to a different protocol. Routers are devices that push traffic through a packet-switched network. As used herein, requests, responses, messages, traffic and packets each refer to digital information traveling over a network. In the Internet, routers are used to determine the best possible route for packets to reach their destination and forward the packets along that route.

### SUMMARY OF THE INVENTION

A method for dynamically setting up a configurable subset of a customer's catalog and saving the subset as an item in the customer's catalog, wherein the customer's catalog was derived from one or more ancestor catalogs. The customer is able to set up and save the subset without intervention by administrators of the one or more ancestor catalogs. A rules based management system is used to derive the customer's catalog at least from a base catalog. The customer is able to set up and save the subset of the customer's catalog in real-time or near real-time. Thus the subset is immediately available for access and ordering. The products, including goods, services and capabilities, that are ordered from the subset are accounted for as if they had been ordered from the customer's regular catalog. Prices for products in the subset are determined by the prices of the components of the product. The subset is identified as an offering that has been released by the customer. Alternatively, the subset can be saved as a sub-catalog of the customer's catalog.

It is an object of the present invention to give customers the ability to create a subset of their catalog and make the subsets immediately available for ordering.

It is another object of the present invention to allow the subset to be created without intervention by administrators of ancestor catalogs.

It is a further object to account for products ordered from the subset catalog in the same manner as if the product had been ordered from the customer's regular catalog.

It is still a further object to reduce lost sales because of delays in the subset creation process and increase customer satisfaction.

### BRIEF DESCRIPTION OF THE DRAWINGS

The invention of the present application will now be described in more detail with reference to the accompanying drawings, given only by way of example, in which:

FIG. 1 is a tree diagram showing related catalogs;

FIG. 2 is a block diagram showing how an exemplary catalog is created;

FIG. 3 shows the relationship between parent and descendent catalogs;

FIG. 4A shows an exemplary step in the present method;

FIG. 4B shows another exemplary step in the present method;

FIG. 5 shows an exemplary method of creating a subset;

FIG. 6 shows an exemplary method for creating a sub-catalog;

FIG. 7 is a flow chart showing the steps for creating a subset; and,

FIG. 8 is a flow chart showing the steps for creating a sub-catalog.

### DETAILED DESCRIPTION OF THE INVENTION

As used herein “customer” is given a very broad definition and, besides its traditional meaning, “customer” also includes retailers, wholesalers, marketers, developers, manufacturers and distributors. A customer, therefore, can be thought of as any “participant” in the cataloging system. A “catalog” as used herein refers to any rules based management system, wherein the customer's catalog is created based on the set of rules, or filters, associated with the customer. The set of rules associated with the customer taken as a whole can be thought of as implementing the policy that exists between the customer and owner, or author, of the catalog.

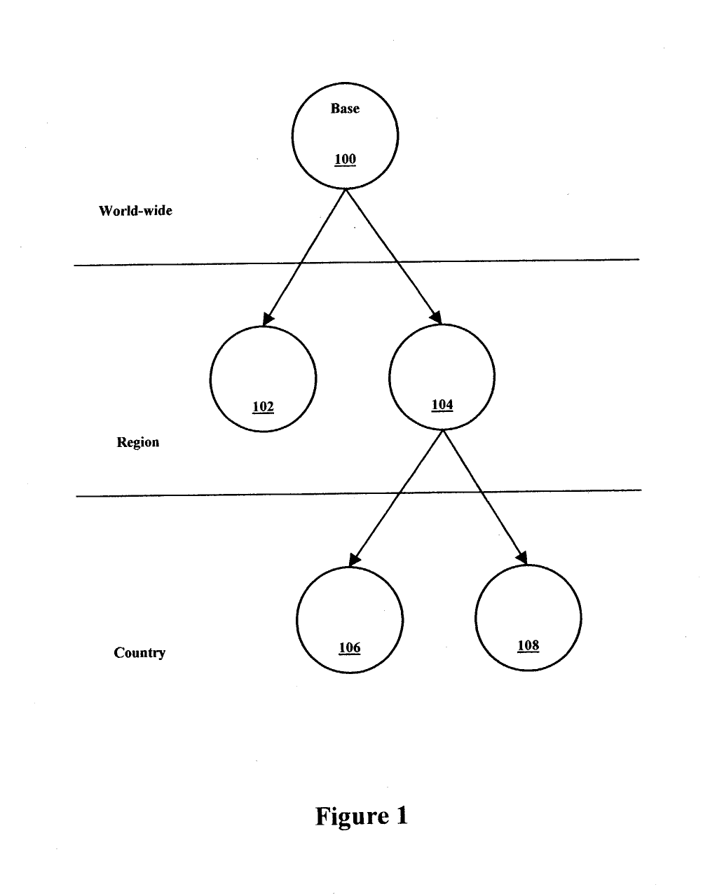

FIG. 1 illustrates the relationship between a base catalog 100 and the catalogs 102, 104, 106, and 108, that are derived therefrom. In practice, the owner of the catalog will list all products, services and capabilities available worldwide in his base catalog 100. Once the base catalog 100 has been defined, inherited versions of the base catalog are available immediately. The owner will then authorize specific organizations, or customers, to sell offerings from their catalogs. The customer may sell directly from the owner's catalog or the customer may create his own catalog structure and tie it to the owner's catalog. If the customer sells from more than one catalog, the customer must create his own catalog structure. During the catalog creation process the products, services and capabilities that are to be listed in the catalog will collectively be referred to as “items”. The owner of the catalog then employees filters, or rules, to derive one or more sub-catalogs 102 and 104 from the base catalog 100. In this example, the filters are selected based on the region of the world in which the sub-catalogs will be available and upon the customers that are to be targeted. Both sub-catalogs 102 and 104 inherit rules from base catalog 100. These inherited rules are either mandatory or optional. Optional rules may be changed locally by administrators of the sub-catalogs. However, mandatory rules cannot be changed without approval from a higher level administrator. Sub-catalogs 102 and 104 are not identical as each sub-catalog has explicit rules that are specific to the individual catalog. The explicit rules can be based on the regions in which the catalogs are employed as well as other factors such as language compatibility or desired manufacturers. The contents of sub-catalog 104 are controlled by inherited rules, from the world-wide level, and explicit rules applied at the regional level. Sub-catalogs 106 and 108 inherit the rules from catalogs 104 and 100, and each may also have explicit rules applied to them based on the country in which they will be available and the targeted customers. FIG. 1 is provided only by way of example and other sub-catalogs can have more than two ancestors. Further, sub-catalog 108 could also be used to derive a lower sub-catalog, for a specific city for example. This type of infrastructure employs a rules based management system and allows the products of multiple sub-catalogs to be changed merely by changing one inherited rule. This eliminates the need to manually add or delete products from many sub-catalogs individually, which can be extremely labor intensive.

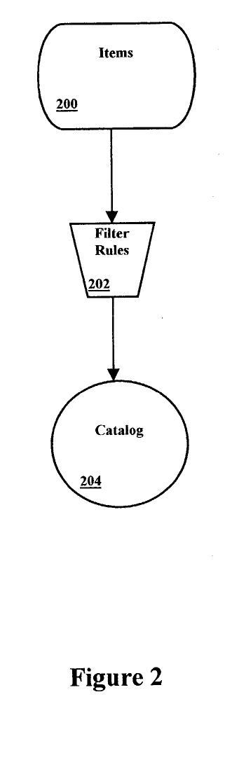

FIG. 2 is a simple block diagram showing how a catalog is created in the present rules based management system. Item list 200 includes all items that are in effect for a given location. As mentioned above, the term “item” includes products, services and capabilities, and can include computer hardware, software, documents or a combination of these. Prices for each item are set by pricing rules. Typically a price is assigned to each component and any item that comprises more than one component will have its price determined by a roll up of the prices of each component. Filter rules 202 contains all rules that are used to determine the items, from item list 200, that will be included in catalog 204. Filter rules 202 include rules relating to price, item qualifications, categories, and producers. Price rules may relate to required profit, tiered pricing and discounts. Qualification rules can be in regards to country and language compatibility, customer specific items, and competitor items. After the rules are applied against item list 200, those items that satisfy the rules will be included in catalog 204. Catalog 204 is created dynamically, meaning that each time the catalog is accessed a new and updated catalog is created. Upon each access, the rules in effect at that time are applied against the items in effect at that time and the catalog is created. Thus, all recently added items and rules will apply to the creation of the catalog when the customer accesses the catalog.

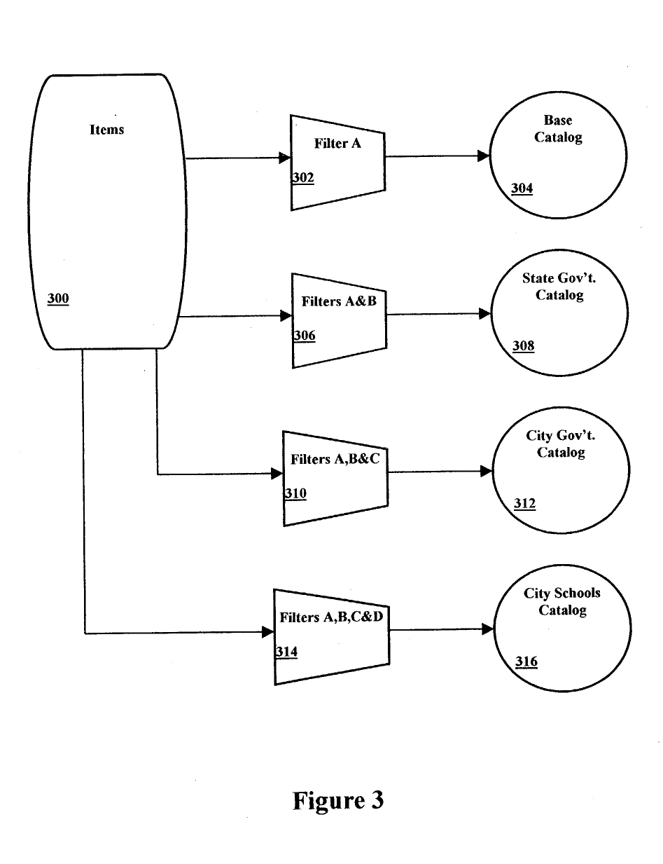

FIG. 3 shows the relationship between a base catalog 304 and the sub-catalogs 308, 312 and 316 that are derived from base catalog 304. In this example, base catalog 304 is created by apply the rules in filter 302 against items 300. State government catalog 308 is created by applying filters 306 against items 300. Filters 306 include rules inherited from filter 302 and explicit rules that are specific to catalog 308. City government catalog 312 is created when the rules in filters 310 are applied against items 300. Filters 310 include rules that are inherited from filters 302 and 306, as well as, explicit rules that are specific to catalog 312. City schools catalog 316 is created every time filters 314 are applied against items 300. Filters 314 include rules that are inherited from filters 302, 306 and 310, as well as, explicit rules that are specific to catalog 316. The explicit rules in filters 306, 310 and 314 can be used to exclude items or to add items to their associated catalogs. Generally, explicit rules will be used to exclude items so that the state government catalog 308 will include, or offer, more items than the city government catalog 312, which will offer more items than the city schools catalog 316.

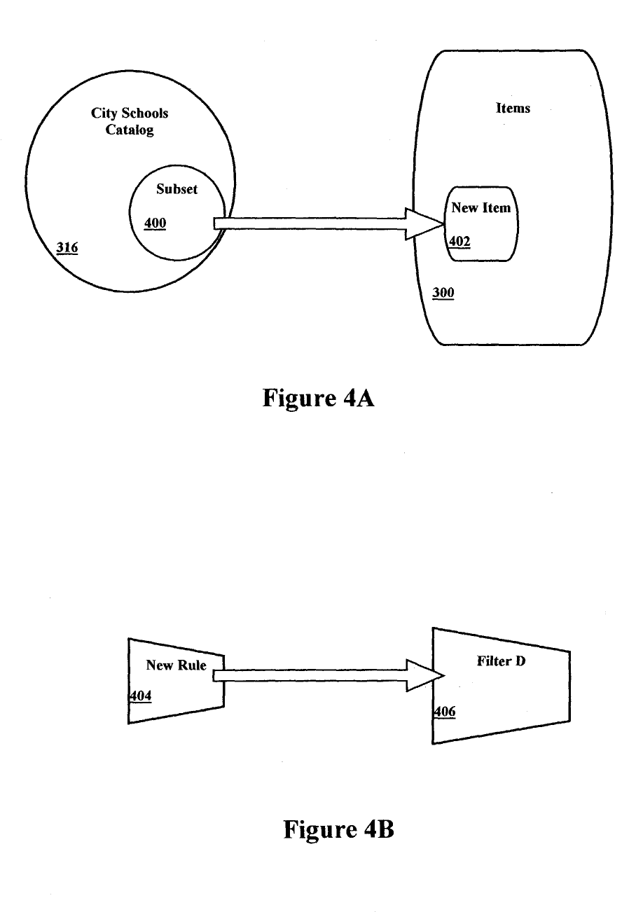

FIG. 4A shows the first steps of the present procedure that allows a customer to create a subset of their catalog. A customer may want to limit the offerings from their catalog to a specific subset for many reasons. For example, the customer may want to limit the access that their employees have to the catalog to a specific subset of the catalog. In such a case, the customer will select items from their catalog 316 to which they want their employees to have access and the selected items will be defined as the subset 400. The customer will then save the subset 400 as a new item 402 in the list of items 300 that is associated with their catalog. While this procedure stretches the definition of “an item” to include multiple item, it also has the benefit of allowing items sold from the subset 400 to be accounted for by traditional methods. Saving the subset 400 as an “item” basically tricks the cataloging system into allowing the customer to do something that the customer would otherwise not be allowed to do, i.e., create a subset of their own catalog without intervention by the authors of the catalog.

FIG. 4B shows the subsequent step that allows the customer to create a subset of their catalog. The customer adds a new rule 404 to the filter 406 for the customer's catalog. The new rule 404 is an explicit rule, meaning that it only affects the customer's catalog and it is not inherited by lower level catalogs. The new rule 404 excludes all items from the customer's catalog except for the “item” that is actually a subset of the customer's catalog. The new rule 404 is saved in the filter 406 that is associated with the customer's catalog. The next time that the customer accesses their catalog, the rules in filter 406 will be applied to the items in effect to generate the customer's catalog. This will result in the customer's catalog being limited to only those items selected by the customer.

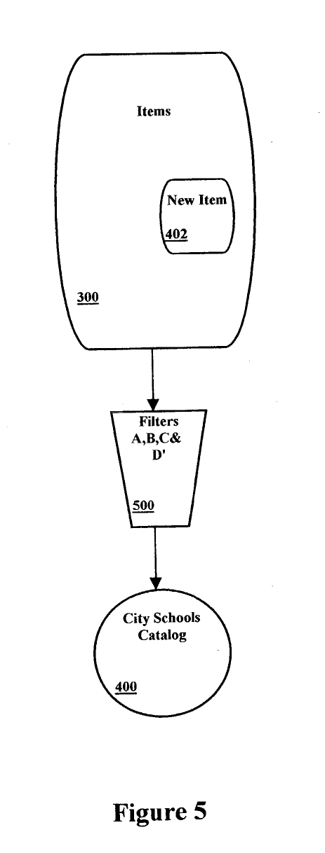

FIG. 5 shows the results of the procedure illustrated in FIGS. 4 A&B, using the catalogs shown in FIG. 3 as an example. Catalog 400 is dynamically created when the customer, including the customer's employees, access the catalog 400. When the customer accesses the catalog 400 the rules in filter 500, which include new rule 404, are applied against the set of items 300 in effect for the customer, which now include new item 402. The use of the symbol “D′” is intended to show that the filter 500 for the city schools catalog includes the new rule 404. When the filter 500 is applied against the set of items 300, the rules in filter 500 are applied in descending order. This means that the rules that were inherited from the base catalog, filter A, are applied first. Then the rules that were inherited from the immediate descendent of the base catalog are applied and so on. When the rules in filter D′ are applied, every item in the set of items 300 is excluded except for item 402, which is included. The result is that the city school catalog 400 is now limited to the subset 400 that was selected by the customer.

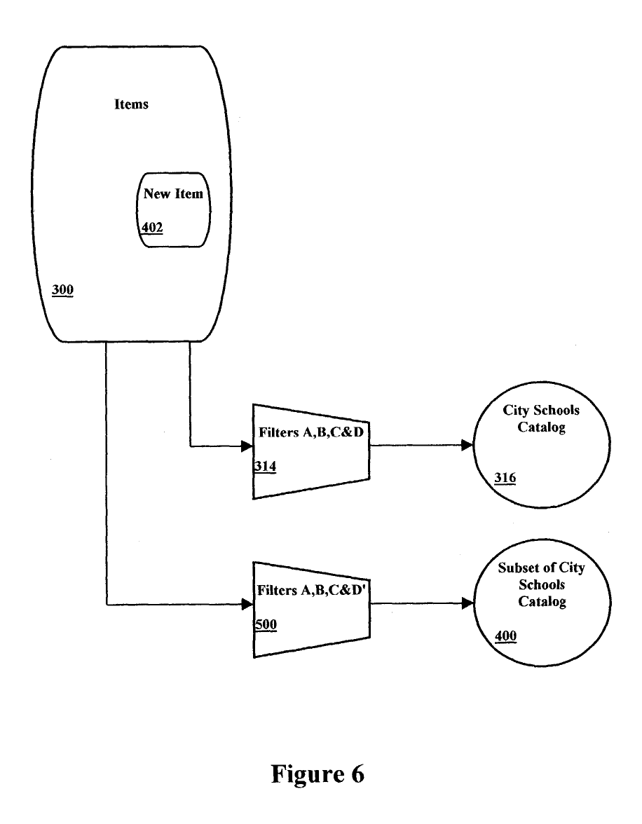

FIG. 6 shows an alternative method for creating a subset of the customer's catalog. In this embodiment, a sub-catalog 400 of the city school catalog is created. A separate structure is created consisting of sub-catalog 400 and filter 500. In FIG. 6, catalog 316 and filter 314 are the same catalog 316 and filter 314 of FIG. 3. Sub-catalog 400 is similar to other sub-catalogs that are derived from ancestor catalogs. However in this case, the sub-catalog 400 contains only one “item”, new item 402, which in most cases will actually include more than one traditional item. Saving and treating the subset as an item allows the subset to acquire all of the accountability features of traditional items. Sub-catalog 400 is created by applying filter 500 against items 300. Filter 500 includes filter rule D′ which excludes all items except new item 402. Thus sub-catalog 400 consists of the subset that was defined by the customer.

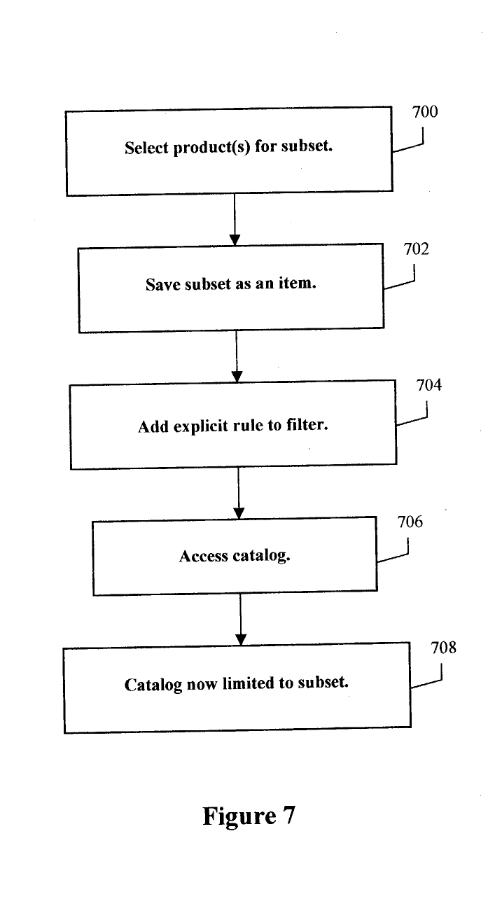

FIG. 7 shows the steps that allow a customer to limit the customer's catalog to a subset of the original catalog. In step 700, the customer selects the products that they want included in the subset. Again, “products” as used herein includes services and capabilities. In step 702, the selected subset is saved as an item in the item list associated with the customer's catalog. In step 704, an explicit rule that excludes all items except the subset-item is added to the filter associated with the customer's catalog. In step 706, the customer accesses the catalog, causing the filter rules to be applied to the list of items. The result, in step 708, is that the customer's catalog is now limited to the subset defined in step 700.

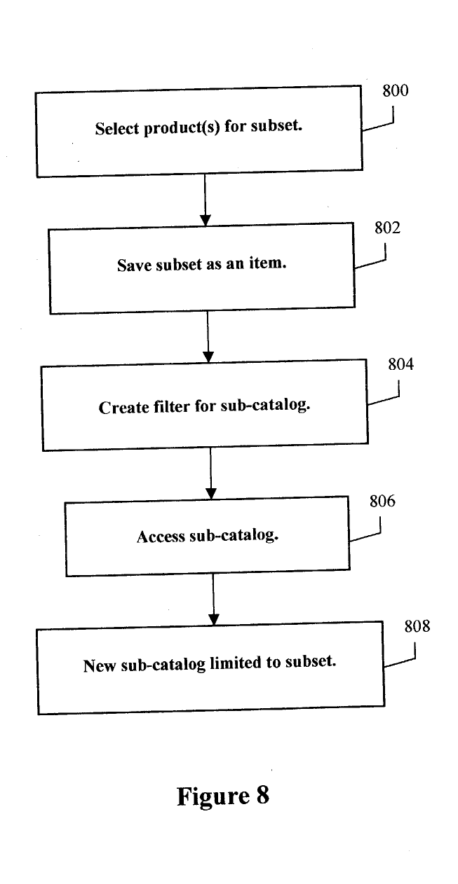

FIG. 8 shows the steps for creating a sub-catalog consisting of a subset of the customer's catalog. In step 800, the customer selects the products that they want included in the subset. In step 802, the selected subset is saved as an item in the item list associated with the customer's catalog. In step 804, a filter is created for the sub-catalog. The filter consists of an explicit rule that excludes all items except the subset-item. In step 806, the customer accesses the sub-catalog causing the filter created in step 804 to be applied to the items associated with the customer. This results in the creation of a new sub-catalog that contains only the subset item.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

We claim:

1. A method for dynamically setting up a configurable subset of a customer's catalog and saving the subset as an item in the customer's catalog, wherein the customer's catalog was derived from one or more ancestor catalogs and a customer is able to set up and save the subset without intervention by administrators of the one or more ancestor catalogs, the method comprising the steps of:
creating a base catalog;
deriving the customer's catalog at least from the base catalog;
setting up, by the customer, a configurable subset of the customer's catalog;
saving the subset as an item in the customer's catalog; and, accounting for products ordered from the subset in a same manner that is used for the customer's catalog, wherein products include goods, services and capabilities.

2. The method of claim 1, further comprising the step of:
identifying the configurable subset of the customer's catalog as an offering released by the customer.

3. The method of claim 1, wherein the step of deriving further comprises:
using a rules based management system to derive the customer's catalog.

4. The method of claim 1, wherein the step of saving comprises:
saving the subset as a sub-catalog to the customer's catalog.

5. The method of claim 1, wherein the step of setting up further comprises:
setting up the configurable subset in real-time or near real-time.

6. The method of claim 1, wherein the step of accounting further comprises:
determining a price for products in the subset based on a roll up of component prices, wherein each product comprises one or more components.

7. The method of claim 1, wherein the steps of setting up and saving further comprise:
setting up and saving more than one subset of the customer's catalog.

8. In a rules based management system, a method for allowing a customer to create and save a subset of a customer's catalog without intervention by an administrator of the management system, wherein everything ordered from the subset is accounted for as if it had been ordered from the customer's catalog, the method comprising the steps of:
selecting products from the customer's catalog to be included in the subset, wherein the products may include services and capabilities;
saving the subset as an item in a list of items associated with the customer's catalog;
adding an explicit rule to a filter associated with the customer's catalog, wherein the explicit rule excludes all items from the customer's catalog except the subset;
accessing the customer's catalog by the customer or an employee of the customer, so that the explicit rule is applied to the list of items; and,
generating a new catalog for the customer, wherein the new catalog consists of the subset.

9. The method of claim 8, further comprising the step of:
identifying the subset as an offering released by the customer.

10. The method of claim 8, wherein each of the steps are accomplished in real-time or near real-time.

11. The method of claim 8, further comprising the step of:
accounting for products ordered from the subset in a same manner that is used for the customer's catalog, wherein products include goods, services and capabilities.

12. The method of claim 11, wherein the step of accounting further comprises:
determining a price for products in the subset based on a roll up of component prices, wherein each product comprises one or more components.

13. In a rules based management system, a method for allowing a customer to create and save a sub-catalog consisting of a subset of a customer's catalog, without intervention by an administrator of the management system, wherein everything ordered from the sub-catalog is accounted for as if it had been ordered from the customer's catalog, the method comprising the steps of:
selecting products from the customer's catalog to be included in the subset, wherein the products may include services and capabilities;
saving the subset as an item in a list of items associated with the customer's catalog;
creating a filter to be used to generate the sub-catalog, wherein the filter includes an explicit rule that excludes all items from the sub-catalog except the subset;
accessing the sub-catalog by the customer, or an employee of the customer, so that the filter is applied to the list of items; and, generating the sub-catalog for the customer, wherein the sub-catalog consists of the subset.

14. The method of claim 13, further comprising the step of:
identifying the sub-catalog as an offering released by the customer.

15. The method of claim 13, wherein each step is accomplished in real-time or near real-time.

16. The method of claim 13, further comprising the step of:
accounting for products ordered from the sub-catalog in a same manner that is used for the customer's catalog, wherein products include goods, services and capabilities.

17. The method of claim 16, wherein the step of accounting further comprises:
determining a price for products in the sub-catalog based on a roll up of component prices, wherein each product comprises one or more components.
